(19) United States
(12) Patent Application Publication
(10) Pub. No.: US 2011/0232459 A1
(43) Pub. Date: Sep. 29, 2011

(54) Bottle Bugle

(76) Inventor: Kaz Kuroki, Saint Louis Park, MN (US)

(21) Appl. No.: 12/731,974

(22) Filed: Mar. 25, 2010

(51) Int. Cl. G10D 7/00

(52) U.S. Cl. 84/330

(57) ABSTRACT

The Bottle bugle is a musical instrument for use with empty or partly empty bottles to make unusual notes or sounds, the Bottle Bugle comprising; a resonant chamber, a bottle cap fastener, and a bell-mouth.

The resonant chamber may be of any shape consistent with being connected to a bottle cap fastener at the first end and a bell-mouth at the second end.

### CROSS REFERENCE TO RELATED APPLICATIONS

There are no applications related to this application.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

This invention pertains to the field of toys and musical instruments.

2. Description of Related Art

Many toys showing the general shape of the present invention have been identified. U.S. design Pat. D600272 to Porter and D548271 to Chang are typical. However, these types of inventions were not conceived for use with empty or partly empty bottles to make unusual notes or sounds.

A large number of instruments exist with U.S. Pat. Nos. 5,133,238 to Ostendorf, and 2,373,110 to Forssberg being typical. The present invention provides its musical and other sounds by air movement supplied by an attached bottle or other device acting as reservoir and resonance chamber in conjunction with the present invention when affixed together as described herein.

### BRIEF SUMMARY OF THE INVENTION

The Bottle bugle is a musical instrument comprising; a resonant chamber, a bottle cap fastener, and a bell-mouth. The resonant chamber may be of any shape consistent with being connected to a bottle cap fastener at the first end and a bell-mouth at the second end.

The bottle cap fastener is affixed to the first end of the resonant chamber by any means whatsoever including, but not limited to, welding, gluing or even casting or molding as a single piece with the resonant chamber.

The Bell-mouth is affixed to the second end of the resonant chamber by any means whatsoever including, but not limited to, welding, gluing or even could be cast or molded as a single piece with the resonant chamber.

### BRIEF DESCRIPTION OF THE SEVERAL DRAWINGS

FIG. 1 is a perspective view of a bottle bugle.

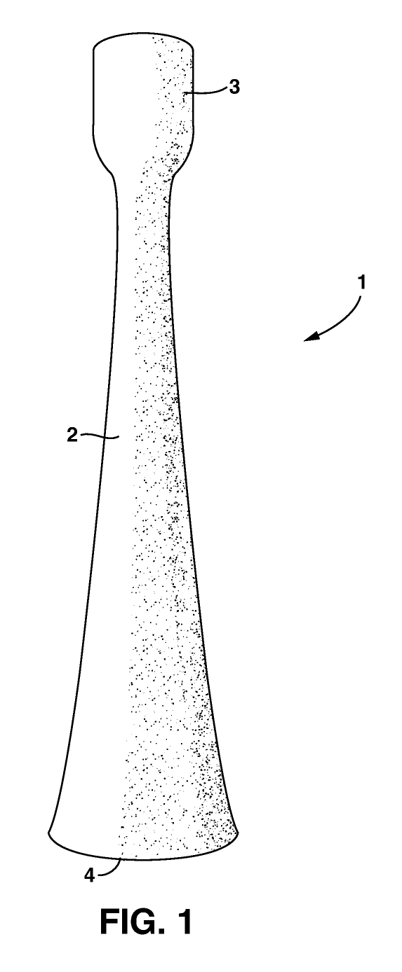

FIG. 2 is a perspective view of another embodiment of the invention.

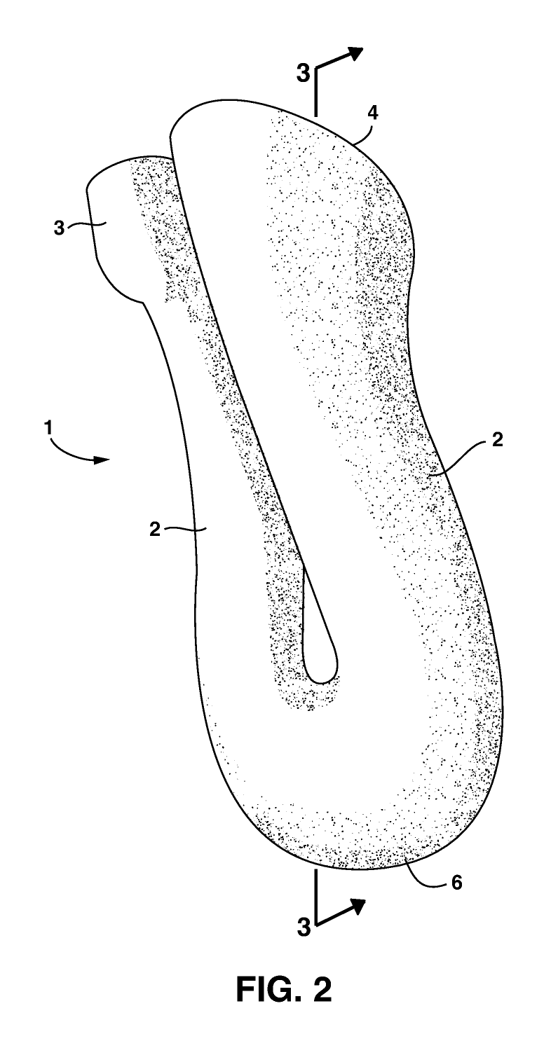

FIG. 3 is a sectional view taken through FIG. 2.

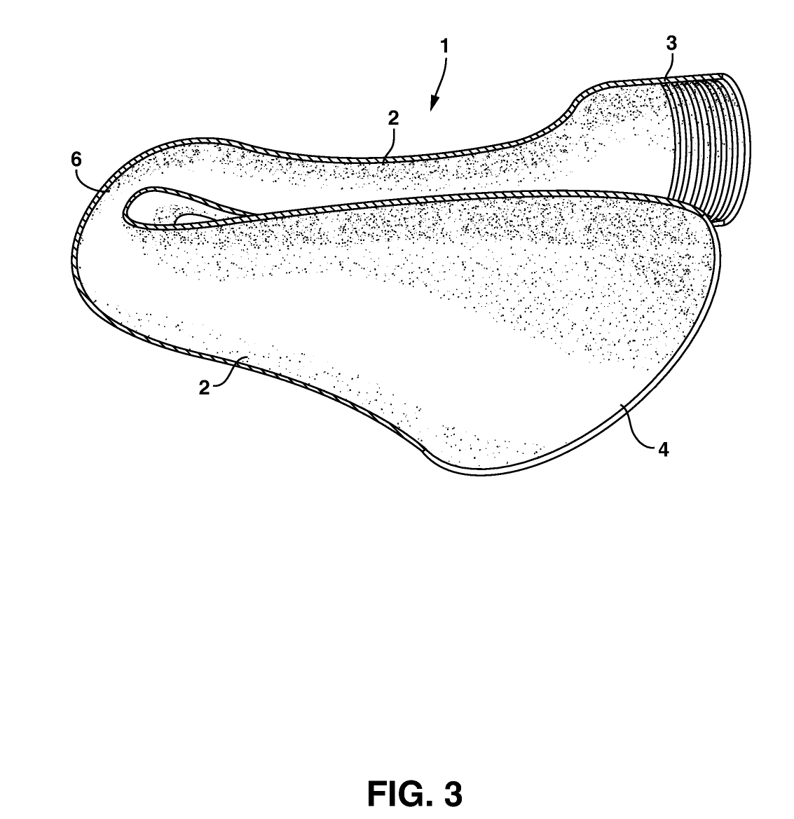

FIG. 4 is a perspective view of the invention in use on a rigid bottle.

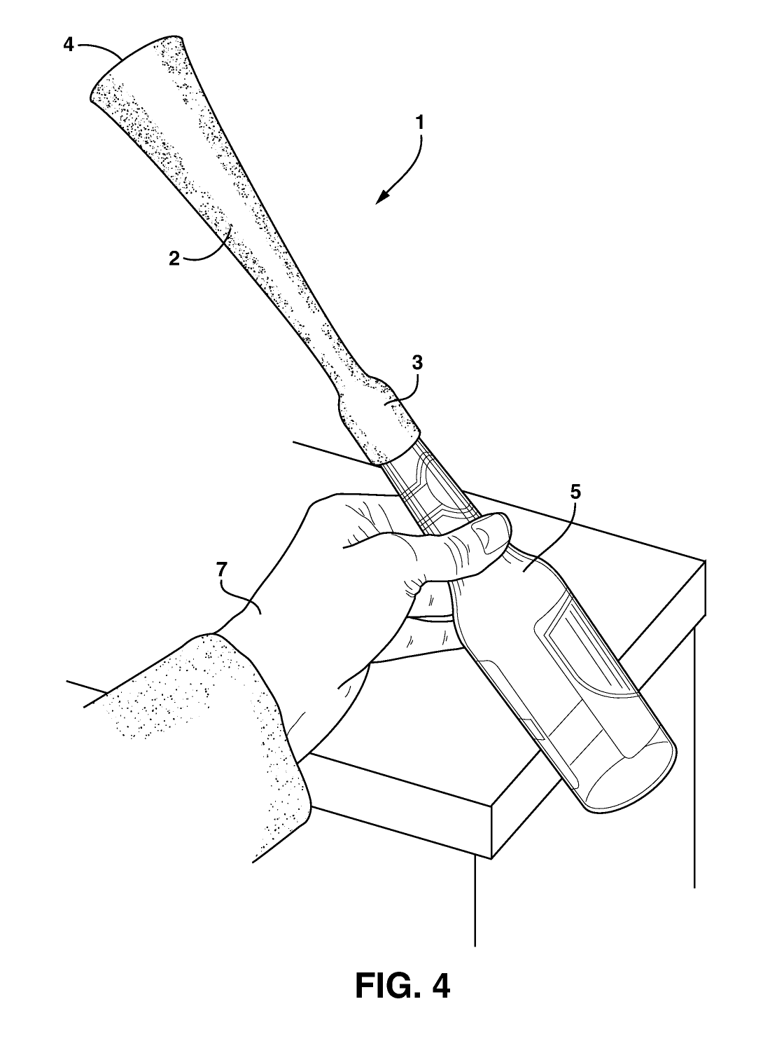

FIG. 5 is a perspective view of the invention in use on a flexible bottle.

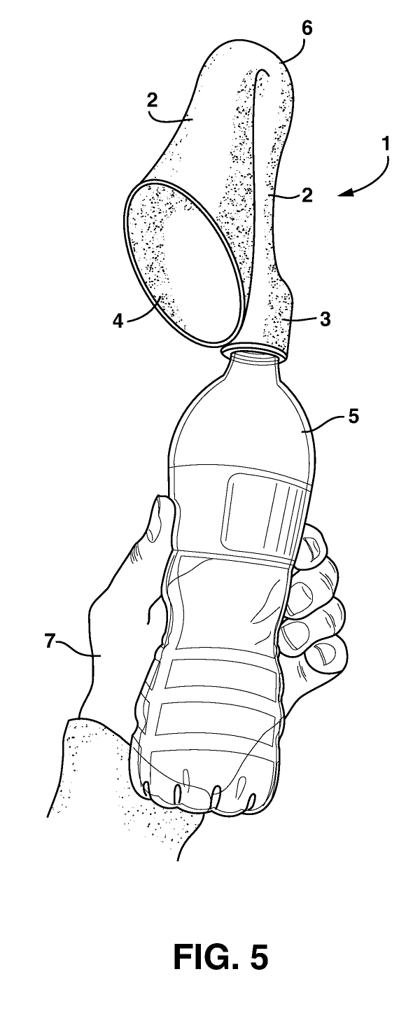

### DETAILED DESCRIPTION OF THE INVENTION

The Bottle bugle 1 is a musical instrument comprising; a resonant chamber 2 having a first and a second end, a bottle cap fastener 3 attached to said first end, and a bell-mouth 4 attached to said second end. It will be appreciated that the bottle cap fastener 3 may be of any suitable type, including but not limited to a screw threaded connection, a friction fitted coupling, or a quick disconnect fitting of any type.

The resonant chamber 2 may be of any shape consistent with being connected to a bottle cap fastener 3 at the first end and a bell-mouth 4 at the second end. However, a frustro-conical shape is thought to provide best compromise between manufacturability and production of tonal resonance. While the simple frustro-conical shape for the resonant chamber 2 is preferred, it will also be appreciated that the resonant chamber 2 may be of such length that one or more bends 6 in the resonant chamber 2 may be included to give Bottle Bugle 1 an appearance reminiscent of other musical instruments such as a Saxophone, Trombone, French Horn, Tuba, or Trumpet. The resonant chamber 2 may be constructed by any suitable means and may be constructed of any suitable material including, but not limited to plastic, metal, wood, or glass. The methods used for forming the resonant chamber will be determined in large measure by the material selected. For example, plastics would likely be one or more moldings, Metals would likely be cast or bent to the desired shape.

Further, the resonant chamber 2 may be enhanced or may be composed of an amplifier or combination of amplifiers of any type including, but not limited to those providing modification of the sounds by mechanical reverberation or electronic circuitry, or a combination of mechanical and electrical means.

The bottle cap fastener 3 is affixed to the first end of the resonant chamber 2 by any means whatsoever including but not limited to welding, gluing or even casting or molding as a single piece with the resonant chamber 2. The bottle cap fastener 3 is hollow to permit passage of air from a bottle 5 or other container to the resonant chamber 2 while detachably attaching the Bottle Bugle 1 to the bottle 5. The bottle cap fastener 3 includes a fitting selected to permit the bottle cap fastener 3 to attach to the neck of a bottle 5. While this fitting may be of many differing types depending on the bottle 5 selected, the most common fitting is believed to be a female screw thread design selected to replace the cap customarily supplied with beverage bottles 5. The bottle cap fastener 3 may be constructed by any suitable means and may be constructed of any suitable material including, but not limited to plastic, metal, wood, or glass.

The Bell-mouth 4 is affixed to the second end of the resonant chamber 2 by any means whatsoever including, but not limited to, welding, gluing or even could be cast or molded as a single piece with the resonant chamber 2. The Bell-mouth 4 may be constructed by any suitable means and may be constructed of any suitable material including, but not limited to plastic, metal, wood, or glass. It will also be recognized that the Bell-mouth 4, bottle cap fastener 3, and the resonant chamber 2 may be constructed as a single piece by any appropriate methods including, but not limited to, casting, molding and machining.

The user 7 plays the Bugle Bottle 5 by striking or squeezing the bottle 5 to which the Bottle Bugle 1 is attached to produce resonant tones or by squeezing a flexible bottle 5 to produce air flow through the Bugle Bottle 5. The user 7 may grasp, the Bottle Bugle 1, the bottle 5, or a combination of the two to accomplish percussion or air movement or both through the Bottle Bugle 1. In any of these methods the sound produced by the bottle 5 is modified by the Bottle Bugle 1 to provide more interesting sounds than the Bottle 5 alone could do.

I claim:

1) A musical instrument comprising:
a) a resonant chamber having a first and a second end;
b) a bottle cap fastener attached to said first end; and
c) a bell-mouth, said bell-mouth attached to said second end.

2) The musical instrument of claim 1 wherein the resonant chamber is frustro-conical in shape.

3) The musical instrument of claim 1 wherein the resonant chamber includes one or more bends.

4) The musical instrument of claim 3 wherein the resonant chamber is frustro-conical in shape.

5) The musical instrument of claim 1 further comprising an sound amplifier.

6) the musical instrument of claim 5 wherein the sound amplifier is electronic.
